(19) United States
(12) Patent Application Publication
(10) Pub. No.: US 2004/0033012 A1
(43) Pub. Date: Feb. 19, 2004

(54) Wavelength division multiplexer

(76) Inventors: Wei-Zhong Li, San Jose, CA (US); Yanbin Shao, San Jose, CA (US); Junfeng Cao, Milpitas, CA (US)

Correspondence Address: FISH & RICHARDSON P.C., 500 ARGUELLO STREET, SUITE 500, REDWOOD CITY, CA, 94063, US

(21) Appl. No.: 10/219,163

(22) Filed: Aug. 13, 2002

(51) Int. Cl. G02B 6/28

(52) U.S. Cl. 385/24

(57) ABSTRACT

A wavelength division multiplexer includes a filter, a first lens, a second lens, a first holder, and a second holder. The pass-band of the filter is dependent on the incident angle of light incident upon the filter. The first lens is positioned on a first side of the filter. The second lens is positioned on a second side of the filter. The first holder is configured to hold at least first, second, third, and fourth fibers proximate to the first lens. The first holder is also configured to hold a center of the second and the fourth fibers on opposite sides of a line connecting a center of the first and the third fibers. The second holder is configured to hold at least fifth and sixth fibers proximate to the second lens.

### BACKGROUND OF THE INVENTION

The present invention relates generally to optical technology.

Wavelength division multiplexers and wavelength division add-drop multiplexers are commonly used in optical communication systems and optical measurement systems. In optical communication systems, a composite signal that includes multiple individual signals each having an individual wavelength can be transmitted over a single fiber. A wavelength division multiplexer can be used to separate a composite signal into multiple individual signals each having an individual wavelength. A wavelength division add-drop multiplexer can be used to drop an individual signal having a first wavelength from a composite signal and add another individual signal having a second wavelength to that composite signal. The second wavelength can be the same as the first wavelength or different from the first wavelength. A wavelength division add-drop multiplexer can also be used to drop plural (e.g., two) individual signals and add plural (e.g., two) individual signals.

### SUMMARY OF THE INVENTION

In one aspect, the invention provides a wavelength division multiplexer. The wavelength division multiplexer includes a filter, a first lens, a second lens, a first holder, and a second holder. The filter is configured to have a pass-band thereof dependent on an incident angle of light incident thereon. The first lens is positioned on a first side of the filter. The second lens is positioned on a second side of the filter. The first holder is configured to hold at least first, second, third, and fourth fibers proximate to the first lens. The first holder is also configured to hold a center of the second and the fourth fibers on opposite sides of a line connecting a center of the first and the third fibers. The second holder is configured to hold at least fifth and sixth fibers proximate to the second lens.

In another aspect, the invention provides a wavelength division add-drop multiplexer. The wavelength division add-drop multiplexer includes a filter, a first lens, a second lens, a first holder, and a second holder. The filter is configured to have a pass-band thereof dependent on an incident angle of light incident thereon. The first lens is positioned on a first side of the filter. The second lens is positioned on a second side of the filter. The first holder is configured to hold at least first, second, third, and fourth fibers proximate to the first lens. The first holder is also configured to hold a center of the second and the fourth fibers on opposite sides of a line connecting a center of the first and the third fibers. The second holder is configured to hold at least fifth, sixth, seventh, and eighth fibers proximate to the second lens. The second holder is also configured to hold a center of the sixth and eighth fibers on opposite sides of a line connecting a center of the fifth and the seventh fibers.

In another aspect, the invention provides a method for manufacturing a wavelength division multiplexer. The method includes the step of configuring a filter to have a pass-band thereof depending on an incident angle of light incident thereon. The method includes the step of positioning a first lens on the first side of the filter. The method includes the step of positioning a second lens on the second side of the filter. The method includes the step of configuring a first holder to hold at least first, second, third, and fourth fibers proximate to the first lens. The method includes the step of configuring the first holder to hold a center of the second and the fourth fibers on opposite sides of a line connecting the centers of the first and the third fibers. The method includes the step of configuring a second holder to hold at least fifth and sixth fibers proximate to the second lens.

In another aspect, the invention provides a method for manufacturing a wavelength division add-drop multiplexer. The method includes the step of configuring a filter to have a pass-band thereof depending on an incident angle of light incident thereon. The method includes the step of positioning a first lens on the first side of the filter. The method includes the step of positioning a second lens on the second side of the filter. The method includes the step of configuring a first holder to hold at least first, second, third, and fourth fibers proximate to the first lens. The method includes the step of configuring the first holder to hold a center of the second and the fourth fibers on opposite sides of a line connecting the centers of the first and the third fibers. The method includes the step of configuring a second holder to hold at least fifth, sixth, seventh, and eighth fibers proximate to the second lens. The method includes the step of configuring the second holder to hold a center of the sixth and eighth fibers on opposite sides of a line connecting the centers of the fifth and the seventh fibers.

Advantages of the invention may include one or more of the following. Implementations of the invention provide wavelength division multiplexers and wavelength division add-drop multiplexers that can have small insertion loss, compact size, and reduced manufacturing cost. The wavelength division multiplexers and wavelength division add-drop multiplexers can add and drop plural individual signals each having an individual wavelength. The wavelength division multiplexers and wavelength division add-drop multiplexers are also designed to remove some limitations imposed on the wavelengths of the plural individual signals. Other advantages will be readily apparent from the attached figures and the description below.

### BRIEF DESCRIPTION OF THE DRAWINGS

FIG. 1a shows an implementation of a wavelength division multiplexer.

FIG. 1b shows the cross section A-A′ of the wavelength division multiplexer in FIG. 1a in the yx plane.

FIG. 1c shows the cross section B-B′ of the wavelength division multiplexer in FIG. 1a in the yx plane.

FIG. 1d shows that wavelengths λ1 and λ2 are related to, respectively, incident angles Φ1 and Φ2.

FIG. 1e shows that the difference between distances d1 and d2 is larger than a certain minimal distance in the implementation of the wavelength division multiplexer in FIG. 1a.

FIGS. 2a and 2b show an implementation of a wavelength division multiplexer, respectively, in the yz plane and the xz plane of a coordinate system.

FIG. 2c shows the cross section A-A′ of the wavelength division multiplexer in FIGS. 2a and 2b in the yx plane.

FIG. 2d shows the cross section B-B′ of the wavelength division multiplexer in FIGS. 2a and 2b in the yx plane.

FIGS. 3a and 3b show an implementation of a wavelength division add-drop multiplexer, respectively, in the yz plane and the xz plane of a coordinate system.

FIG. 3c shows the cross section A-A′ of the wavelength division add-drop multiplexer in FIGS. 3a and 3b in the yx plane.

FIG. 3d shows the cross section B-B′ of the wavelength division add-drop multiplexer in FIGS. 3a and 3b in the yx plane.

### DETAILED DESCRIPTION OF THE INVENTION

The present invention relates to an improvement in optical technology. The following description is presented to enable one of ordinary skill in the art to make and use the invention and is provided in the context of a patent application and its requirements. Various modifications to the invention will be readily apparent to those skilled in the art and the generic principals herein may be applied to other embodiments. Thus, the present invention is not intended to be limited to the embodiments shown, but is to be accorded the widest scope consistent with the principals and features described herein.

The present invention will be described in terms of wavelength division multiplexers and wavelength division add-drop multiplexers each having specific components having specific configurations. Similarly, the present invention will be described in terms of components having specific relationships, such as distances or angles between components. However, one of ordinary skill in the art will readily recognize that the devices and systems described can include other components having similar properties, other configurations, and other relationships between components.

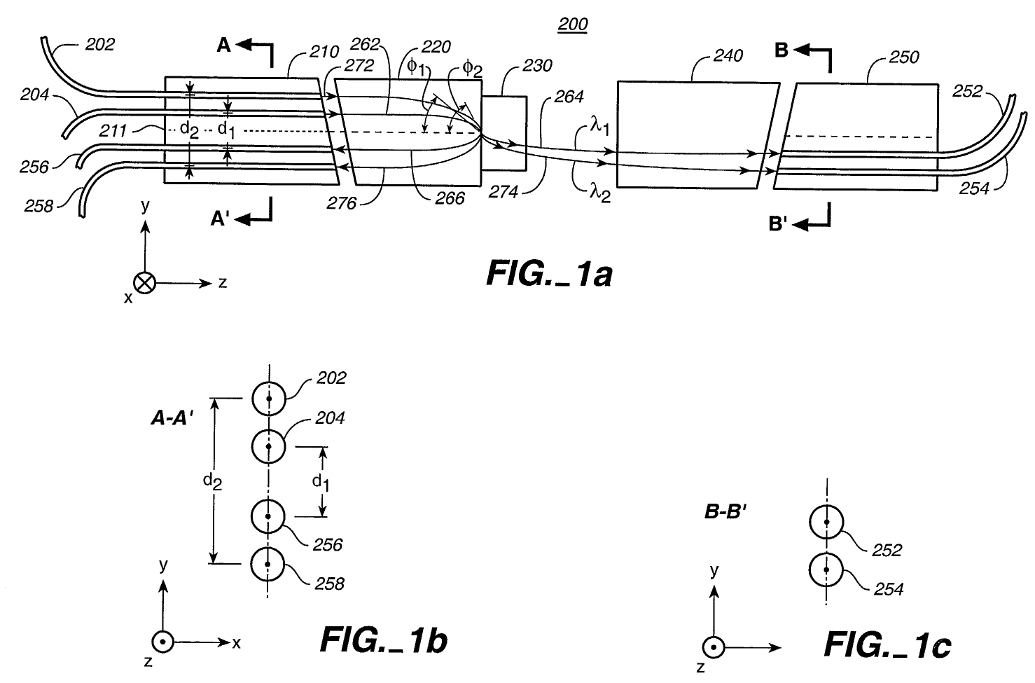

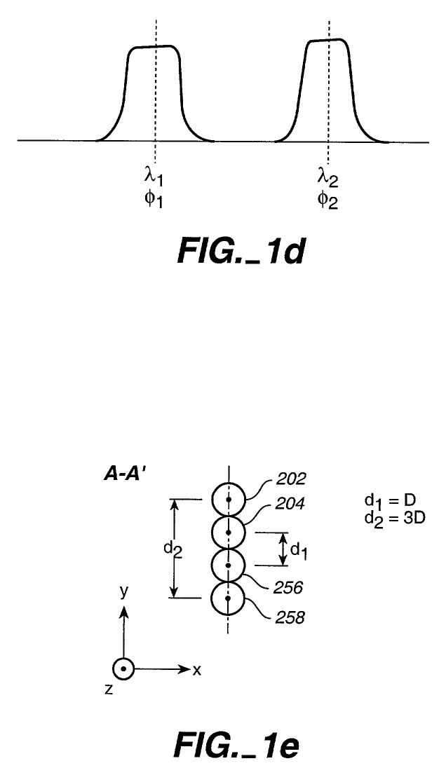

FIG. 1a illustrates an implementation of a wavelength division multiplexer 200. The detailed description of this implementation of wavelength division multiplexers can be found in U.S. Pat. No. 6,084,994, titled “Tunable, Low Back-reflection Wavelength Division Multiplexer”, which is incorporated herein by reference in its entirety.

As shown in FIG. 1a, wavelength division multiplexer 200 includes a first lens 220, a filter 230, and a second lens 240. Filter 230 is a device designed in such a way such that the pass-band of filter 230 depends on the incident angle of light incident upon filter 230. Four fibers 202, 204, 256 and 258 are positioned at one side of first lens 220. First lens 220 is configured and positioned to collimate optical signals exiting from the end of fibers 202 and 204. First lens 220 is also configured and positioned to focus optical signals to enter the end of fibers 256 and 258. Two fibers 252 and 254 are positioned at a distal end of second lens 240. Second lens 240 is configured and positioned to focus optical signals to enter the end of fibers 252 and 254. Fibers 202, 204, 256, and 258 can be fixed in position by a first holder 210. Fibers 252 and 254 can be fixed in position by a second holder 250. First holder 210 and second holder 250 each can be a capillary.

As shown in FIG. 1a, fibers 204 and 256 are separated by distance d1, and fibers 202 and 258 by distance d2. In FIG. 1a, wavelength division multiplexer 200 is shown in the yz plane of a coordinate system. The cross sections A-A′ and B-B′ of wavelength division multiplexer 200 in FIG. 1a is shown, respectively, in FIG. 1b and FIG. 1c, in the yx plane. FIG. 1b shows that the center of fibers 204 and 256 are separated by distance d1, and the center of fibers 202 and 258 by distance d2.

In FIG.1a, light signal 262 exiting from fiber 204 is collimated by first lens 220 and is incident upon filter 230 with an incident angle Φ2. Light signal 262 in general is a composite signal that includes multiple individual signals each having an individual wavelength. The individual signal with wavelength λ1 is transmitted through filter 230 as light signal 264, and the individual signals with wavelengths other than λ1 are reflected by filter 230 as light signal 266. Light signal 264 is focused by second lens 240 and enters fiber 252. Light signal 266 is focused by first lens 220 and enters fiber 256.

In FIG. 1a, light signal 272 exiting from fiber 202 is collimated by first lens 220 and is incident upon filter 230 with an incident angle Φ2. Light signal 272 in general is a composite signal that includes multiple individual signals each having an individual wavelength. The individual signal with wavelength λ2 is transmitted through filter 230 as light signal 274, and the individual signals with wavelengths other than λ2 are reflected by filter 230 as light signal 276. Light signal 274 is focused by second lens 240 and enters fiber 254. Light signal 276 is focused by first lens 220 and enters fiber 258.

As described above, wavelength division multiplexer 200 can be designed to separate a first individual signal with wavelength λ1 and a second individual signal with wavelength λ2 into two fibers. As shown in FIG. 1d, wavelengths λ1 and λ2 are related to, respectively, incident angles Φ1 and Φ2. Incident angles Φ1 and Φ2 are further related to, respectively, distances d1 and d2. If the difference between distances d1 and d2 is limited to be larger than a certain minimal distance, the difference between wavelengths λ1 and λ2 in general will also be limited to be larger than a certain minimal wavelength-difference.

FIG. 1e illustrates that, in some implementations of wavelength division multiplexer 200, the difference between distances d1 and d2 is larger than a certain minimal distance. More specifically, fibers 202, 204, 256, and 258 are generally in the form of fiber optic cables. A fiber optic cable can include a core, cladding, coating, strengthening fibers, and cable jacket. The core is for transmitting light. In general, the thickness of a fiber optic cable can be significantly larger than the thickness of the core in the fiber optic cable. FIG. 1e illustrates that, in the implementation of wavelength division multiplexer 200 in FIG. 1a, the centers of fibers 202, 204, 256, and 258 are approximately collinear. If fibers 202, 204, 256, and 258 are generally in the form of fiber optic cables each has an outer diameter D, then, the minimal distance between the centers of fibers 204 and 256 is D, and the minimal distance between the centers of fibers 202 and 258 is 3D. That is, distance d1 has a minimal value of D, distance d2 has a minimal value of 3D. If the outer diameter D=125 μm, then, distance d1 has a minimal value d1=125 μm, and distance d2 has a minimal value d2=375 μm. Since the difference between distances d1 and d2 is limited to be larger than 2D, the difference between wavelengths λ1 and λ2 is limited to be larger than a certain minimal wavelength-difference.

In certain applications, a preferred implementation of wavelength division multiplexer should not have minimal limitations imposed on the difference between wavelengths λ1 and λ2. In the implementations of wavelength division multiplexer to be described below, no minimal limitations are imposed on the difference between wavelengths λ1, and λ2. In fact, in some of these implementations, the difference between wavelengths λ1 and λ2 can be zero.

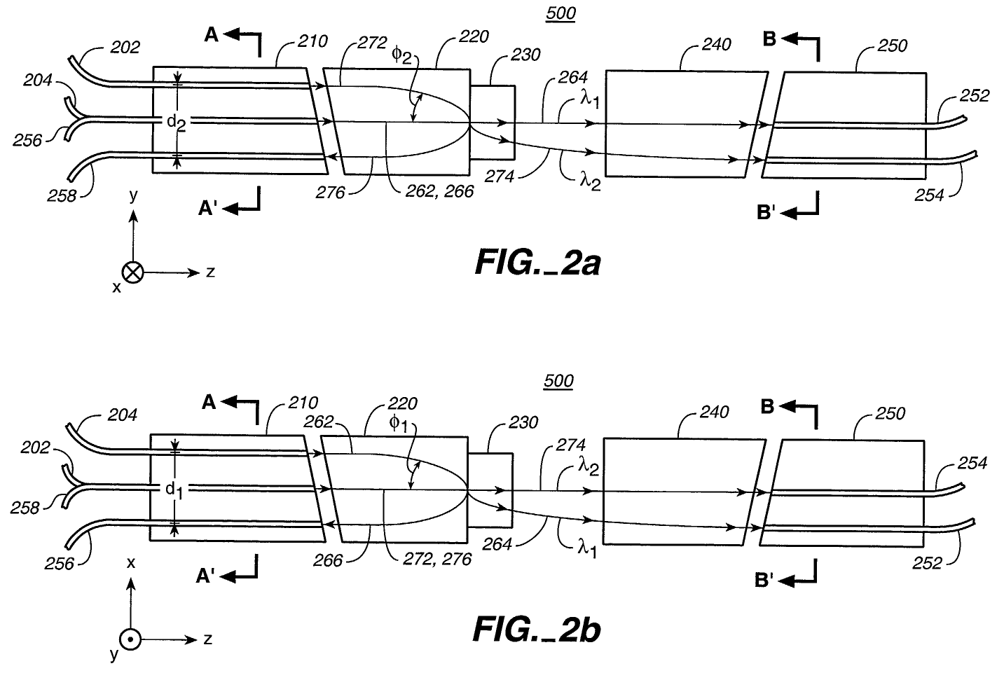

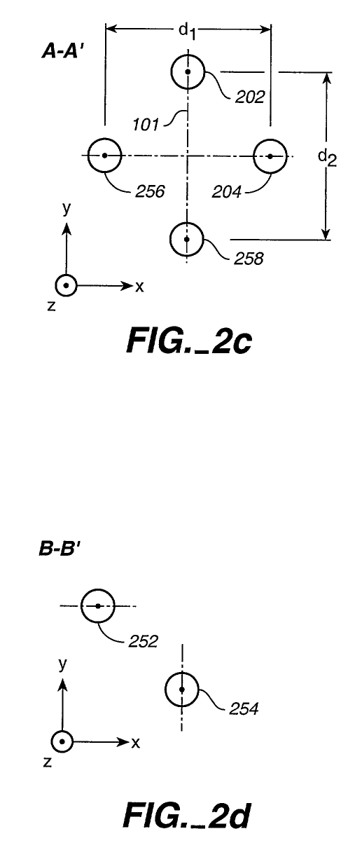

FIGS. 2a and 2b illustrate an implementation of a wavelength division multiplexer 500, respectively, in the yz plane and the xz plane of a coordinate system. Wavelength division multiplexer 500 includes a first lens 220, a filter 230, and a second lens 240. Filter 230 is a device designed in such a way that the pass-band of filter 230 depends on the incident angle of light incident thereon. Four fibers 202, 204, 256 and 258 are positioned at one side of first lens 220. First lens 220 is configured and positioned to collimate optical signals exiting from the end of fibers 202 and 204. First lens 220 is also configured and positioned to focus optical signals to enter the end of fibers 256 and 258. Two fibers 252 and 254 are positioned at a distal end of second lens 240. Second lens 240 is configured and positioned to focus optical signals to enter the end of fibers 252 and 254. Fibers 202, 204, 256, and 258 can be fixed in position by a first holder 210. Fibers 252 and 254 can be fixed in position by a second holder 250. First holder 210 and second holder 250 each can be a capillary.

In FIG. 2a, wavelength division multiplexer 500 is shown in the yz plane, and fibers 202 and 258 are separated by distance d2. In FIG. 2b, wavelength division multiplexer 500 is shown in the xz plane, and fibers 204 and 256 are separated by distance d1. The cross section A-A′ of wavelength division multiplexer 500 in FIGS. 2a and 2b is shown in FIG. 2c in the yx plane. The cross section B-B′ of wavelength division multiplexer 500 in FIGS. 2a and 2b is shown in FIG. 2d in the yx plane. FIG. 2c shows that the center of fibers 204 and 256 are separated by distance d1, and the center of fibers 202 and 258 by distance d2. The center of fibers 204 and 256 are positioned on opposite sides of a line 101 connecting the center of fibers 202 and 258.

In FIGS. 2a and 2b, light signal 272 exiting from fiber 202 is collimated by first lens 220 and is incident upon filter 230 with incident angle Φ2. Light signal 272 in general is a composite signal that includes multiple individual signals each having an individual wavelength. The individual signal with wavelength λ2 is transmitted through filter 230 as light signal 274, and the individual signals with wavelengths other than λ2 are reflected by filter 230 as light signal 276. Light signal 274 is focused by second lens 240 and enters fiber 254. Light signal 276 is focused by first lens 220 and enters fiber 258.

In FIGS. 2a and 2b, light signal 262 exiting from fiber 204 is collimated by first lens 220 and is incident upon filter 230 with incident angle Φ1. Light signal 262 in general is a composite signal that includes multiple individual signals each having an individual wavelength. The individual signal with wavelength λ1 is transmitted through filter 230 as light signal 264, and the individual signals with wavelengths other than λ1 are reflected by filter 230 as light signal 266. Light signal 264 is focused by second lens 240 and enters fiber 252. Light signal 266 is focused by first lens 220 and enters fiber 256.

As described above, wavelength division multiplexer 500 can be designed to separate a first individual signal with wavelength λ1 and a second individual signal with wavelength λ2 into two fibers. The implementation of wavelength division multiplexer 500 in FIGS. 2a and 2b includes at least the advantage that the difference between distances d1 and d2 can be as small as zero. Consequently, the difference between wavelengths λ1 and λ2 can also be as small as zero.

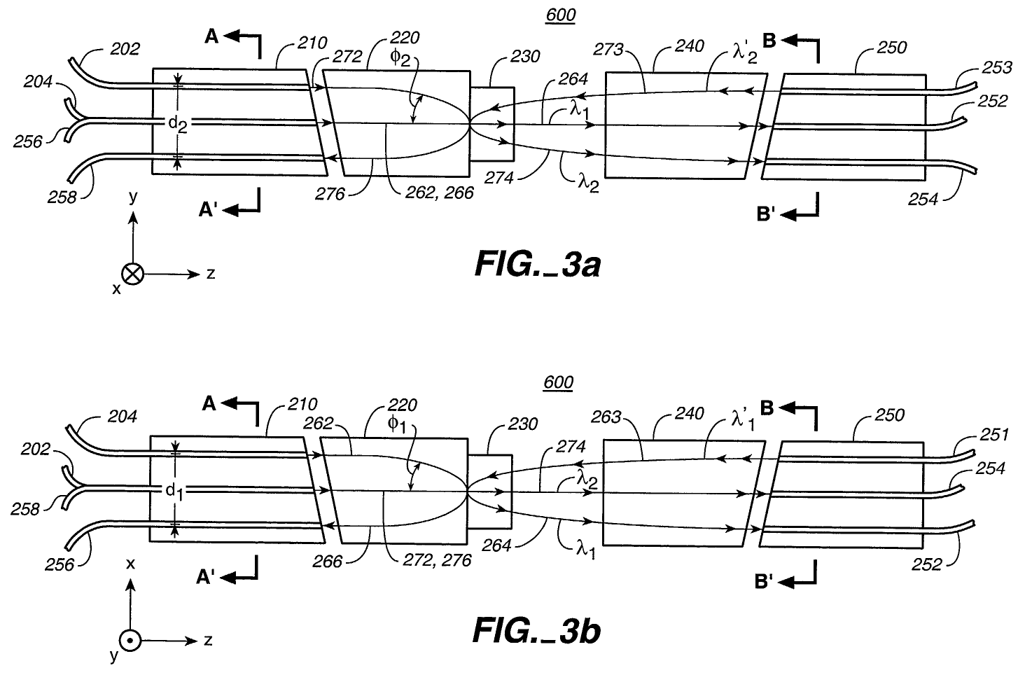

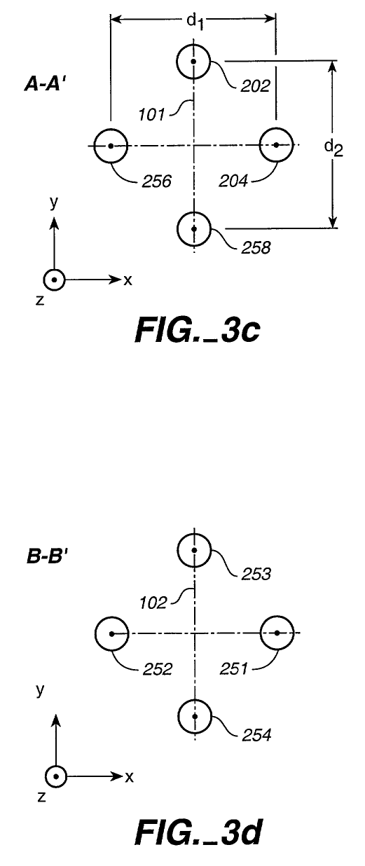

FIGS. 3a-3d illustrate that wavelength division multiplexer 500 in FIGS. 2a-2d can be modified to become a wavelength division add-drop multiplexer 600. Wavelength division multiplexer 500 is modified by modifying second holder 250 in such a way that two additional fibers 251 and 253 can be fixed and positioned at the distal end of second lens 240. Fibers 251 and 253 are positioned in such a way that light signals exiting from fibers 251 and 253 are collimated by second lens 240.

The cross section A-A′ of wavelength division add-drop multiplexer 600 in FIGS. 3a and 3b is shown in the yx plane in FIG. 3c. The cross section B-B′ of wavelength division add-drop multiplexer 600 in FIGS. 3a and 3b is shown in the yx plane in FIG. 3d. As shown in FIG. 3d, the centers of fibers 251 and 252 are positioned on opposite sides of a line 102 connecting the center of fibers 253 and 254.

As shown in FIGS. 3a-3b, light signal 273 with wavelength λ2′ exiting from fibers 253 is collimated by second lens 240 and incident upon filter 230. Light signal 273 with wavelength λ2′ pass though filter 230 and is added to light signal 276. Light signal 276 is focused by first lens 220 and enters fiber 258.

As shown in FIGS. 3a-3b, light signal 263 with wavelength λ1′ exiting from fibers 251 is collimated by second lens 240 and incident upon filter 230. Light signal 263 with wavelength λ1′ pass though filter 230 and is added to light signal 266. Light signal 266 is focused by first lens 220 and enters fiber 256.

The implementation of wavelength division multiplexer 500 includes at least the advantage that the difference between distances d1 and d2 can be as small as zero. Consequently, the difference between wavelengths S1 and S2 can also be as small as zero.

In FIGS. 2a and 2b, wavelength division multiplexer 500 can be designed to separate a first individual signal with wavelength λ1 and a second individual signal with wavelength λ2 into two fibers. If the pass-band of filter 230 covers the wavelengths of a plurality of individual signals, wavelength division multiplexer 500 can be designed to separate a first group of individual signals and a second group of individual signals into two fibers. Similarly, if the pass-band of filter 230 covers the wavelengths of a plurality of individual signals, wavelength division add-drop multiplexer 600 in FIGS. 3a and 3b can be designed to add groups of individual signals and drop groups of individual signals.

A method and system has been disclosed for providing wavelength division multiplexers and wavelength division add-drop multiplexers. Although the present invention has been described in accordance with the implementations shown, one of ordinary skill in the art will readily recognize that there could be variations to the implementations and those variations would be within the spirit and scope of the present invention. For example, an optical isolator can be placed between filter 230 and second lens 240, for wavelength division multiplexer 500 in FIGS. 2a-2d or for wavelength division add-drop multiplexer 600 in FIGS. 3a-3d. Accordingly, many modifications may be made by one of ordinary skill in the art without departing from the spirit and scope of the appended claims.

What is claimed is:

1. A wavelength division multiplexer comprising:
a filter configured to have a pass-band thereof dependent on an incident angle of light incident thereon;
a first lens positioned on a first side of the filter;
a second lens positioned on a second side of the filter;
a first holder configured to hold at least first, second, third, and fourth fibers proximate to the first lens, wherein the first holder is configured to hold a center of the second and the fourth fibers on opposite sides of a line connecting a center of the first and the third fibers; and
a second holder configured to hold at least fifth and sixth fibers proximate to the second lens.

2. The wavelength division multiplexer of claim 1 further comprising an optical isolator positioned between the filter and the second lens.

3. The wavelength division multiplexer of claim 1 wherein the filter is in contact with the first lens.

4. The wavelength division multiplexer of claim 1 wherein the first holder is configured to hold a center of the first and the third fibers in such a way that light exiting from the first fiber is reflected by the filter into the third fiber if the light exiting from the first fiber has a wavelength outside the pass-band of the filter.

5. The wavelength division multiplexer of claim 4 wherein the second holder is configured to hold a center of the fifth fiber in such a way that light exiting from the first fiber is transmitted through the filter and is directed into the fifth fiber by the second lens if the light exiting from the first fiber has a wavelength within the pass-band of the filter.

6. The wavelength division multiplexer of claim 1 wherein the first holder is configured to hold a center of the second and the fourth fibers in such a way that light exiting from the second fiber is reflected by the filter into the fourth fiber if the light exiting from the second fiber has a wavelength outside the pass-band of the filter.

7. The wavelength division multiplexer of claim 6 wherein the second holder is configured to hold a center of the sixth fiber in such a way that light exiting from the second fiber is transmitted through the filter and is directed into the sixth fiber by the second lens if the light exiting from the second fiber has a wavelength within the pass-band of the filter.

8. A wavelength division add-drop multiplexer comprising:
a filter configured to have a pass-band thereof dependent on an incident angle of light incident thereon;
a first lens positioned on a first side of the filter;
a second lens positioned on a second side of the filter;
a first holder configured to hold at least first, second, third, and fourth fibers proximate to the first lens, wherein the first holder is configured to hold a center of the second and the fourth fibers on opposite sides of a line connecting a center of the first and the third fibers; and
a second holder configured to hold at least fifth, sixth, seventh, and eighth fibers proximate to the second lens, wherein the second holder is configured to hold a center of the sixth and eighth fibers on opposite sides of a line connecting a center of the fifth and the seventh fibers.

9. The wavelength division add-drop multiplexer of claim 8 further comprising an optical isolator positioned between the filter and the second lens.

10. The wavelength division add-drop multiplexer of claim 8 wherein the filter is in contact with the first lens.

11. The wavelength division add-drop multiplexer of claim 8 wherein the first holder is configured to hold a center of the first and the third fibers in such a way that light exiting from the first fiber is reflected by the filter into the third fiber if the light exiting from the first fiber has a wavelength outside the pass-band of the filter.

12. The wavelength division add-drop multiplexer of claim 11 wherein the second holder is configured to hold a center of the fifth fiber in such a way that light exiting from the first fiber is transmitted through the filter and is directed into the fifth fiber by the second lens if the light exiting from the first fiber has a wavelength within the pass-band of the filter.

13. The wavelength division add-drop multiplexer of claim 12 wherein the second holder is configured to hold a center of the seventh fiber in such a way that light exiting from the seventh fiber is transmitted through the filter and is directed into the third fiber by the first lens if the light exiting from the seventh fiber has a wavelength within the pass-band of the filter.

14. The wavelength division add-drop multiplexer of claim 8 wherein the first holder is configured to hold a center of the second and the fourth fibers in such a way that light exiting from the second fiber is reflected by the filter into the fourth fiber if the light exiting from the second fiber has a wavelength outside the pass-band of the filter.

15. The wavelength division add-drop multiplexer of claim 14 wherein the second holder is configured to hold a center of the sixth fiber in such a way that light exiting from the second fiber is transmitted through the filter and is directed into the sixth fiber by the second lens if the light exiting from the second fiber has a wavelength within the pass-band of the filter.

16. The wavelength division add-drop multiplexer of claim 15 wherein the second holder is configured to hold a center of the eighth fiber in such a way that light exiting from the eighth fiber is transmitted through the filter and is directed into the fourth fiber by the first lens if the light exiting from the eighth fiber has a wavelength within the pass-band of the filter.

17. The wavelength division add-drop multiplexer of claim 8 wherein the pass-band of the filter for the light exiting from the first fiber is substantially identical to the pass-band of the filter for the light exiting from the seventh fiber.

18. The wavelength division add-drop multiplexer of claim 8 wherein the pass-band of the filter for the light exiting from the second fiber is substantially identical to the pass-band of the filter for the light exiting from the eighth fiber.

19. A method for manufacturing a wavelength division multiplexer comprising:
configuring a filter to have a pass-band thereof depending on an incident angle of light incident thereon;
positioning a first lens on the first side of the filter;
positioning a second lens on the second side of the filter;
configuring a first holder to hold at least first, second, third, and fourth fibers proximate to the first lens;
configuring the first holder to hold a center of the second and the fourth fibers on opposite sides of a line connecting the centers of the first and the third fibers; and
configuring a second holder to hold at least fifth and sixth fibers proximate to the second lens.

20. The method of claim of 19 further comprising positioning an optical isolator between the filter and the second lens.

21. The method of claim 19 further comprising contacting the filter with the first lens.

22. The method of claim 19 further comprising configuring the first holder to hold a center of the first and the third fibers such that light exiting from the first fiber is reflected by the filter into the third fiber if the light exiting from the first fiber has a wavelength outside the pass-band of the filter.

23. The method of claim 22 further comprising configuring the second holder to hold a center of the fifth fiber in such a way that light exiting from the first fiber is transmitted through the filter and is directed into the fifth fiber by the second lens if the light exiting from the first fiber has a wavelength within the pass-band of the filter.

24. The method of claim 19 further comprising configuring the first holder to hold a center of the second and the fourth fibers in such a way that light exiting from the second fiber is reflected by the filter into the fourth fiber if the light exiting from the second fiber has a wavelength outside the pass-band of the filter.

25. The method of claim 24 further comprising configuring the second holder to hold a center of the sixth fiber in such a way that light exiting from the second fiber is transmitted through the filter and is directed into the sixth fiber by the second lens if the light exiting from the second fiber has a wavelength within the pass-band of the filter.

26. A method for manufacturing a wavelength division add-drop multiplexer comprising:
configuring a filter to have a pass-band thereof depending on an incident angle of light incident thereon;
positioning a first lens on the first side of the filter;
positioning a second lens on the second side of the filter;
configuring a first holder to hold at least first, second, third, and fourth fibers proximate to the first lens;
configuring the first holder to hold a center of the second and the fourth fibers on opposite sides of a line connecting the centers of the first and the third fibers;
configuring a second holder to hold at least fifth, sixth, seventh, and eighth fibers proximate to the second lens; and
configuring the second holder to hold a center of the sixth and eighth fibers on opposite sides of a line connecting the centers of the fifth and the seventh fibers.

27. The method of claim of 26 further comprising positioning an optical isolator between the filter and the second lens.

28. The method of claim 26 further comprising contacting the filter with the first lens.

29. The method of claim 26 further comprising configuring the first holder to hold a center of the first and the third fibers in such a way that light exiting from the first fiber is reflected by the filter into the third fiber if the light exiting from the first fiber has a wavelength outside the pass-band of the filter.

30. The method of claim 29 further comprising configuring the second holder to hold a center of the fifth fiber in such a way that light exiting from the first fiber is transmitted through the filter and is directed into the fifth fiber by the second lens if the light exiting from the first fiber has a wavelength within the pass-band of the filter.

31. The method of claim 30 further comprising configuring the second holder to hold a center of the seventh fiber in such a way that light exiting from the seventh fiber is transmitted through the filter and is directed into the third fiber by the first lens if the light exiting from the seventh fiber has a wavelength within the pass-band of the filter.

32. The method of claim 26 further comprising configuring the first holder to hold a center of the second and the fourth fibers in such a way that light exiting from the second fiber is reflected by the filter into the fourth fiber if the light exiting from the first fiber has a wavelength outside the pass-band of the filter.

33. The method of claim 32 further comprising configuring the second holder to hold a center of the sixth fiber in such a way that light exiting from the second fiber is transmitted through the filter and is directed into the sixth fiber by the second lens if the light exiting from the third fiber has a wavelength within the pass-band of the filter.

34. The method of claim 33 further comprising configuring the second holder to hold a center of the eighth fiber in such a way that light exiting from the eighth fiber is transmitted through the filter and is directed into the fourth fiber by the first lens if the light exiting from the eighth fiber has a wavelength within the pass-band of the filter.

35. The method of claim 26 wherein the pass-band of the filter for the light exiting from the first fiber is substantially identical to the pass-band of the filter for the light exiting from the seventh fiber.

36. The method of claim 26 wherein the pass-band of the filter for the light exiting from the second fiber is substantially identical to the pass-band of the filter for the light exiting from the eighth fiber.
